(19) United States
(12) Patent Application Publication
(10) Pub. No.: US 2026/0030944 A1
(43) Pub. Date: Jan. 29, 2026

(54) Consensus Building Support Device, Consensus Building Support Method, and Recording Medium

(71) Applicant: Hitachi, Ltd., Tokyo (JP)

(72) Inventors: Yasuhiro ASA, Tokyo (JP); Takashi NUMATA, Tokyo (JP)

(21) Appl. No.: 19/265,123

(22) Filed: Jul. 10, 2025

(30) Foreign Application Priority Data
Jul. 29, 2024 (JP) 2024-122600

(51) Int. Cl. G07C 13/00

(52) U.S. Cl. CPC G07C 13/00

(57) ABSTRACT

A consensus building support device includes: processor configured to execute a program; a storage device configured to store the program; and a communication interface configured to communicate with a plurality of communication terminals used by a plurality of participants. The processor executes: acquisition processing of receiving, from the communication terminals, an opinion related to a discussion for determining any one option from among a plurality of options, as a result of transmitting information related to the discussion to the plurality of communication terminals; specifying processing of specifying an option selected by the participant for each opinion received by the acquisition processing; combining processing of combining the opinions based on the option specified by the specifying processing; and transmission processing of transmitting, to the communication terminals, a combination result obtained by combining the opinions by the combining processing.

### CROSS REFERENCE TO RELATED APPLICATIONS

This application claims priority from Japanese Patent Application No. 2024-122600 filed on Jul. 29, 2024, the entire subject matter of which is incorporated herein by reference.

### BACKGROUND OF THE INVENTION

### 1. Field of the Invention

The present invention relates to a consensus building support device, a consensus building support method, and a consensus building support program that support consensus building.

### 2. Description of Related Art

PTL 1 below discloses a requirement confirmation support device. In the requirement confirmation support device, a stakeholder determination unit classifies each stakeholder into a cluster, and a cluster distribution generation unit generates cluster distribution information of the stakeholders. A requirement definition model generation unit generates a cluster distribution model based on a requirement definition model. An assent degree measurement unit measures assent information for each stakeholder with respect to each item of the requirement definition, and the cluster-specific assent degree generation unit aggregates the assent information for each cluster and calculates an assent degree for each cluster. Then, based on these pieces of information, a cluster distribution display screen, a requirement definition model display screen, and a cluster-specific assent degree display screen are displayed.

### CITATION LIST

### Patent Literature

PTL 1: JP2008-217480A

### SUMMARY OF THE INVENTION

In an online consent system in the related art, although a consensus building discussion is performed based on opinion postings of participants for a plurality of options, there is no support for determining one option (consensus plan), the option is finally determined by majority of voting, and it is difficult to determine a consensus plan that all the participants can satisfy.

An object of the invention is to support facilitation of consensus building.

A consensus building support device as one aspect of the invention disclosed in the present application includes: a processor configured to execute a program; a storage device configured to store the program; and a communication interface configured to communicate with a plurality of communication terminals used by a plurality of participants. The processor executes: acquisition processing of receiving, from the communication terminals, an opinion related to a discussion for determining any one option from among a plurality of options, as a result of transmitting information related to the discussion to the plurality of communication terminals; specifying processing of specifying an option selected by the participant for each opinion received by the acquisition processing; combining processing of combining the opinions based on the option specified by the specifying processing; and transmission processing of transmitting, to the communication terminals, a combination result obtained by combining the opinions by the combining processing.

According to a representative embodiment of the invention, it is possible to support facilitation of consensus building. Problems, configurations, and effects other than those described above will be clarified by descriptions of the following embodiments.

### BRIEF DESCRIPTION OF THE DRAWINGS

FIG. 1 is a diagram showing an example of consensus building support.

FIG. 2 is a diagram showing details of a consensus building screen.

FIG. 3 is a diagram showing a system configuration example of a consensus building support system.

FIG. 4 is a block diagram showing a hardware structure example of a computer.

FIG. 5 is a diagram showing an example of a database.

FIG. 6 is a flowchart showing an example of a consensus building processing procedure of the consensus building support system.

FIG. 7 is a diagram showing an example 1 of a display screen of a communication terminal.

FIG. 8 is a diagram showing an example 1 of an opinion history table.

FIG. 9 is a diagram showing an example 2 of the display screen of the communication terminal.

FIG. 10 is a diagram showing an example 3 of the display screen of the communication terminal.

FIG. 11 is a diagram showing an example 4 of the display screen of the communication terminal.

FIG. 12 is a diagram showing an example 5 of the display screen of the communication terminal.

FIG. 13 is a diagram showing an example 2 of the opinion history table.

FIG. 14 is a diagram showing an example 6 of the display screen of the communication terminal.

FIG. 15 is a diagram showing the example 6 of the display screen of the communication terminal.

### DESCRIPTION OF EMBODIMENTS

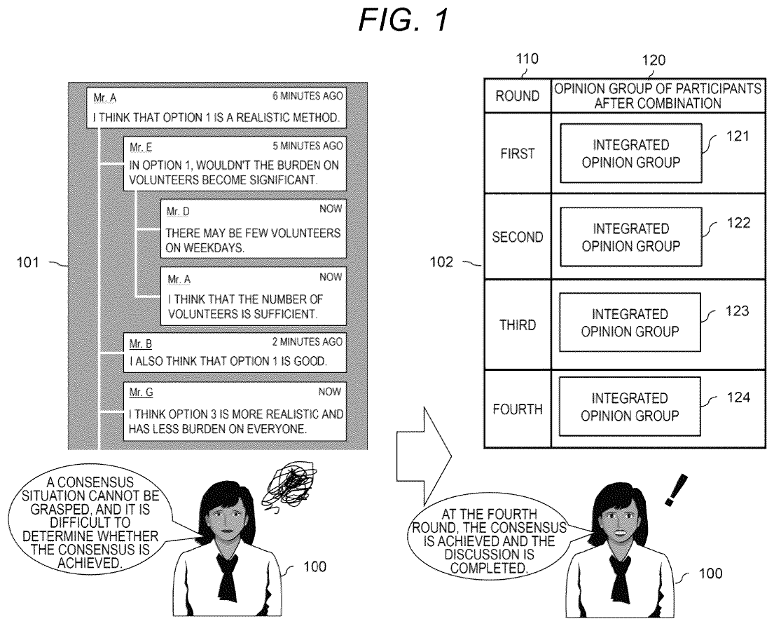

### FIG. 1 Consensus Building Support

FIG. 1 is a diagram showing an example of consensus building support. A consensus building screen 101 is, for example, a screen example showing a result of a consensus building discussion based on opinion postings of participants for a plurality of options in an online consent system in the related art.

In the online consent system in the related art, a participant posts an opinion in a thread of a discussion theme without being limited to a divergence phase and a convergence phase, and the discussion proceeds in a form of replying to each opinion. That is, each participant responds while browsing the consensus building screen 101 on which opinions are displayed in a hierarchical structure. In this case, since the participants respond to a specific opinion at timings close in time, a large number of new opinion postings are displayed on the consensus building screen 101 at the same time, and it is difficult to browse the new opinion postings. Since the frequency of the opinion postings depends on an operational skill of each participant, a participant with a low skill cannot post an opinion at an appropriate timing and is difficult to participate in the discussion. Due to these problems, it is not possible to secure sufficient time for browsing and responding.

A facilitator 100 can perform a completion determination for each phase, but depends on a determination skill of the facilitator 100. It is also possible to use the online consent system in a state where there is no facilitator 100, but in the completion determination in this case, the determination depends on a time limit for a divergence phase, and the determination depends on the time limit and voting for a convergence phase. Such completion determination is not desirable because it is difficult to say that the discussion has been fully discussed and the participants are dissatisfied.

Therefore, on the consensus building screen 101, a consensus situation cannot be grasped, and it is difficult to determine whether the consensus is achieved. Therefore, there is no support for determining one option (consensus plan), and the option is finally determined by majority of voting, and it is difficult to determine a consensus plan that all the participants can satisfy.

In the embodiment, a consensus building screen 102 is generated and displayed in the online consent system. The consensus building screen 102 organizes results of the discussion performed in a round form for each of time series rounds 110 of one or more times (four times as an example in FIG. 1) as an opinion group 140 of the participants after integration, and displays integrated opinion groups 121 to 124 for each round 110. The facilitator 100 can sequentially browse the integrated opinion groups 121 to 124, achieve a consensus in the fourth round, and determine that the discussion is completed.

In the following description, participants A to E will be described as an example for convenience of description, but the number of participants is not limited to 5. Similarly, in the following description, for convenience of description, options 1 to 7 will be described as an example, but the number of options is not limited to seven.

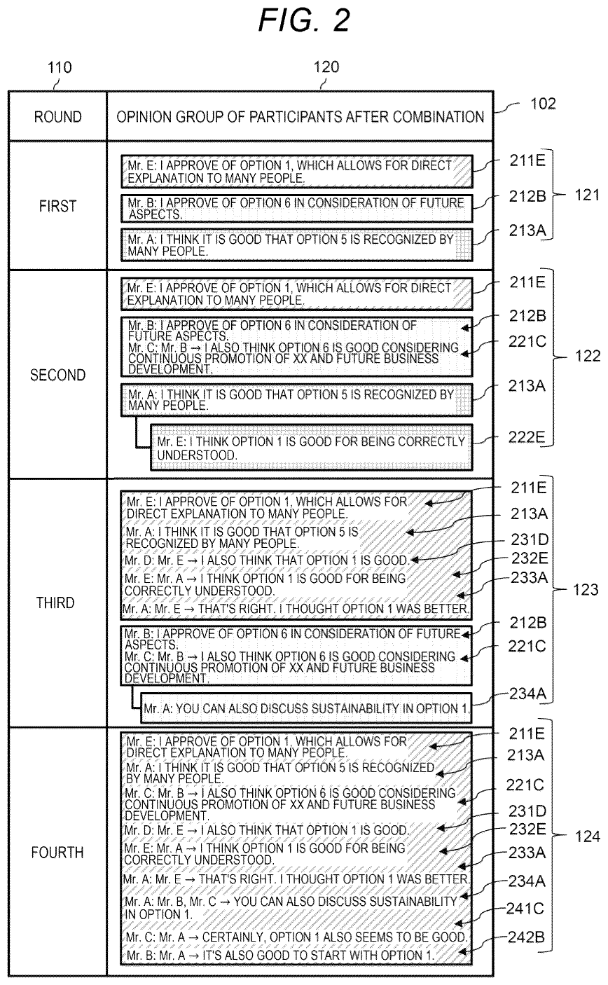

### FIG. 2 Details of Consensus Building Screen 102

FIG. 2 is a diagram showing details of the consensus building screen 102. FIG. 2 shows details of the integrated opinion groups 121 to 124. The n-th (n is an integer of 1 or more) round 110 is referred to as an n-th round 110.

Each of the integrated opinion groups 121 to 124 is configured with an individual opinion or an integrated opinion obtained by integrating a plurality of individual opinions. The individual opinion includes a participant name of a transmission source of the opinion and a character string indicating the opinion content. The individual opinion is referred to as a symbol of 2nmX. m is an integer starting from 1 and indicates a transmission order in the n-th round. X is capital letters A, B, C, . . . for uniquely identifying participants. When the participants A, B, C, . . . are not distinguished from each other, they are referred to as participants X. Similarly, when the individual opinions are not distinguished from each other, they are referred to as opinions 2nmX.

In this example, an example in which 5 participants A to E discuss which one option of seven options is better is shown.

In the first round 110, opinions 211E, 212B, and 213A are displayed.

In the second round 110, opinions 221C and 222E are newly added. The opinion 212B and opinion 221C are combined in time series. Since the opinion 222E is an opinion for the opinion 213A and has a different option, the opinion 222E is combined with the opinion 213A as a lower hierarchy of the opinion 213A.

In the third round 110, opinions 231D, 232E, and 233A are newly added. Opinions 211E, 213A, 231D, 232E, and 233A are combined in time series. The opinion 213A is an opinion of the participant A who has selected the option 5 in the first round 110, but the participant A selects the option 1 in the opinion 233A of the third round 110 thereafter. Therefore, the opinion 213A is included in a combined opinion {opinions 211E, 213A, 231D, 232E, 233A}.

Since the opinion 213A is an opinion for the combined opinion {212B, 221C} and has a different option from the combined opinion {212B, 221C}, the opinion 213A is combined with the combined opinion {212B, 221C} as a lower hierarchy of the combined opinion {212B, 221C}.

In the fourth round 110, opinions 241C and 242B are newly added. Opinions 211E, 213A, 221C, 231D, 232E, 233A, 213A, 241C, and 242B are integrated in time series. That is, since there is only one figure indicating the opinion, the facilitator 100 can intuitively determine that the consensus is achieved in the fourth round 110 and the discussion is completed. In this example, it can be seen that all the participants A to E have achieved the consensus in the option 1. In the embodiment, it is possible to increase the assent degree of the consensus plan (option 1) of all the participants A to E by supporting the determination of whether such consensus building is made.

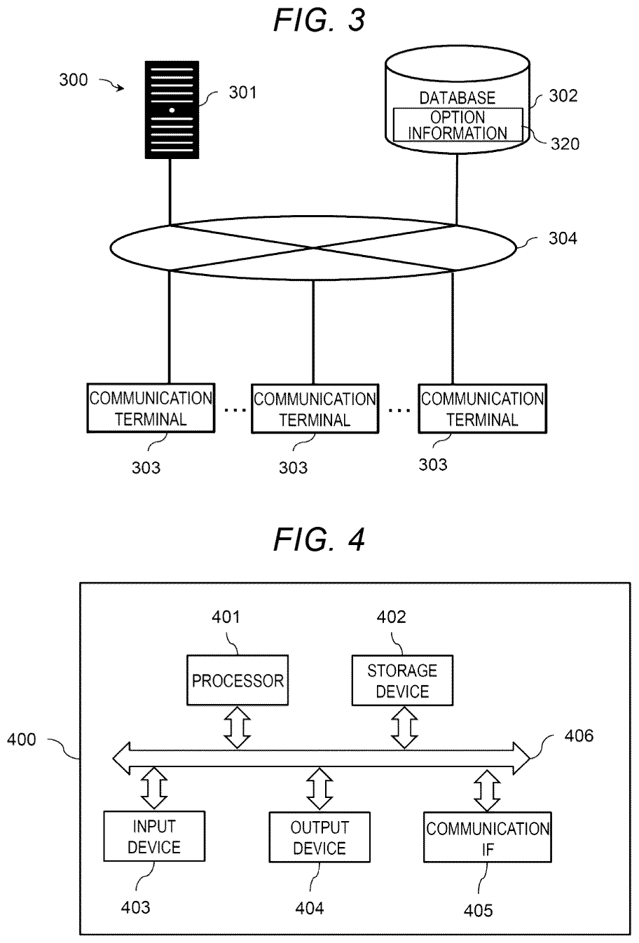

### FIG. 3 System Configuration Example of Consensus Building Support System

FIG. 3 is a diagram showing a system configuration example of a consensus building support system 300. The consensus building support system 300 includes a consensus building support device 301, a database 302, and communication terminals 303. The consensus building support device 301, the database and the communication terminals 303 are communicably connected with one another via a network 304 such as the Internet, a local area network (LAN), or a wide area network (WAN).

The consensus building support device 301 is a computer that receives opinions input to the communication terminals 303, generates the consensus building screen 102, and transmits the consensus building screen 102 to the communication terminals 303 in a displayable manner. The communication terminal 303: is a computer used by the participants A to E and the facilitator 100. The database 302 is a storage device that stores option information 320. The option information 320 is information including the options 1 to 7 described above. One of the participants A to E may also serve as the facilitator 100.

### FIG. 4 Computer (Consensus Building Support Device 301, Communication Terminal 303)

FIG. 4 is a block diagram showing a hardware structure example of a computer. A computer 400 includes a processor 401, a storage device 402, an input device 403, an output device 404, and a communication interface (communication IF) 405. The processor 401, the storage device 402, the input device 403, the output device 404, and the communication IF 405 are connected to one another by a bus 406. The processor 401 controls the computer 400. The storage device 402 is a work area of the processor 401. The storage device 402 is a non-transitory or transitory recording medium that stores various programs or data. Examples of the storage device 402 include a read only memory (ROM), a random access memory (RAM), a hard disk drive (HDD), and a flash memory. The input device 403 inputs data. Examples of the input device 403 include a keyboard, a mouse, a touch panel, a numeric keypad, a scanner, a microphone, and a sensor. The output device 404 outputs data. Examples of the output device 404 include a display, a printer, and a speaker. The communication IF 405 is connected to a network to transmit and receive data.

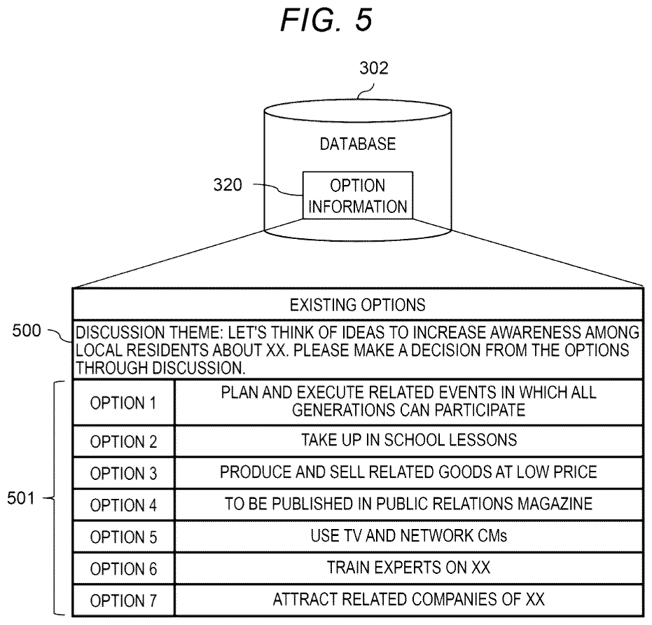

### FIG. 5 Database 302

FIG. 5 is a diagram showing an example of the database 302. The database 302 stores the option information 320. The option information 320 includes an existing option 500 and an option group 501 (a plurality of options 1 to 7). The existing option 500 is a character string indicating a theme of a discussion, and prompts the participants A to E to determine one option from the option group 501 (the plurality of options 1 to 7).

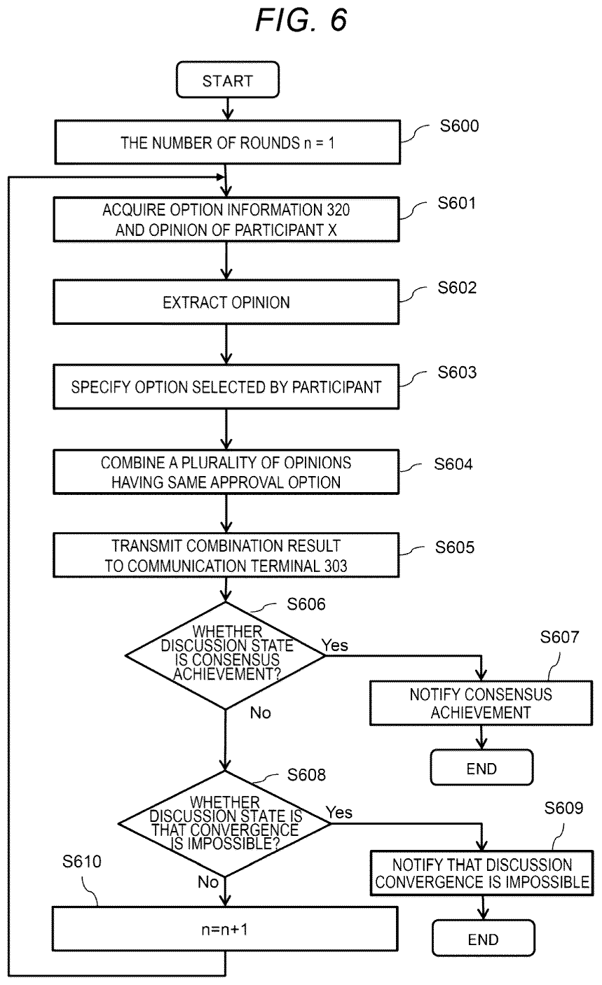

### FIG. 6 Consensus Building Processing Procedure of Consensus Building Support System 300

FIG. 6 is a flowchart showing an example of a consensus building processing procedure of the consensus building support system 300.

### Step S600

The consensus building support device 301 sets the number of rounds n to n=1, reads the option information 320 from the database 302, and transmits the start of the n-th round 110, a time limit of the n-th round, and the option information 320 to the communication terminal 303. Accordingly, when receiving the start of the n-th round 110, the communication terminal 303 counts down the time limit. Thereafter, the participants A to E discuss the n-th round 110. The time limit is freely set in the consensus building support device 301. The time limit is, for example, 10 minutes.

### Step S601

The consensus building support device 301 acquires the opinion 2nmX of the participant X. Specifically, for example, the consensus building support device 301 receives opinion information of the participant X from the communication terminal 303. The opinion information includes the opinion 2nmX and a transmission date and time thereof (which may be a date and time when the opinion 2nmx is input). In addition, when the participant X designates that the opinion 2nmX is an opinion responding to another previous opinion in the communication terminal 303, designation information for designating an opinion of a response source is also included.

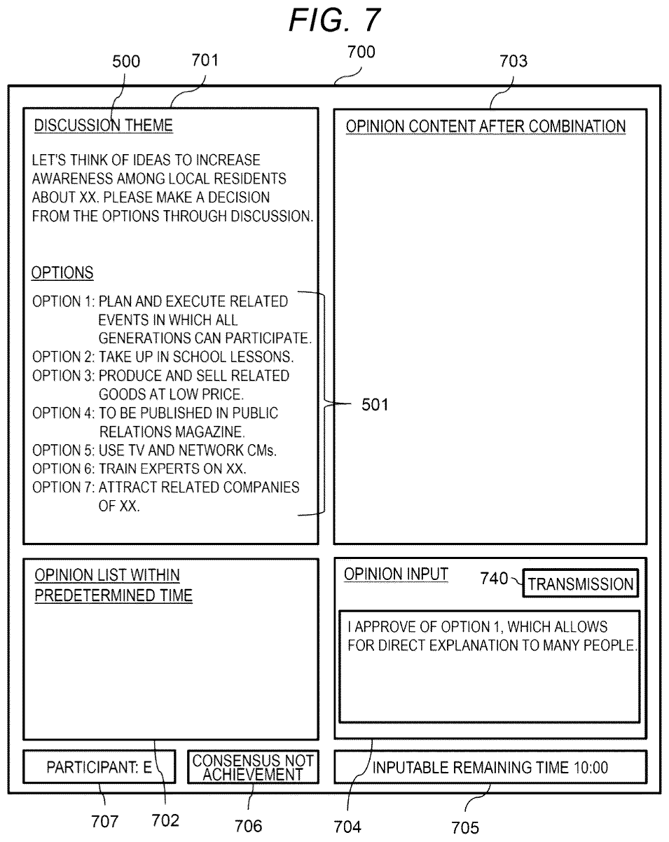

### FIG. 7 Example 1 of Display Screen (First Round 110)

FIG. 7 is a diagram showing an example 1 of a display screen of the communication terminal 303. FIG. 7 shows an example of a display screen 700 displayed on the communication terminal 303 of the participant E. The display screen 700 includes an option information display region 701, an opinion list display region 702, a combined opinion display region 703, an opinion input region 704, a remaining time display region 705, a consensus state display region 706, and a participant display region 707.

The option information display region 701 is a region for displaying the option information 320. The opinion list display region 702 is a region for displaying response source designation information for designating, as the response source, the opinion 2nmX displayed in the combined opinion display region 703. The combined opinion display region 703 is a region for displaying a combination result in step S604 described later. The opinion input region 704 is a region in which the participant X inputs the opinion 2nmX and displays the input opinion 2nmX. When a transmission button 740 is pressed, the opinion 2nmX input to the opinion input region 704 is transmitted to the consensus building support device 301.

The remaining time display region 705 is a region for displaying a remaining time obtained by counting down the time limit in the n-th round 110. The consensus state display region 706 is a region for displaying a consensus state indicating whether a discussion has achieved a consensus. The consensus state display region 706 displays “consensus not achievement” in default, and is changed to “consensus achievement” when consensus achievement is received from the consensus building support device 301. The participant display region 707 is a region for displaying a participant name of the participant X.

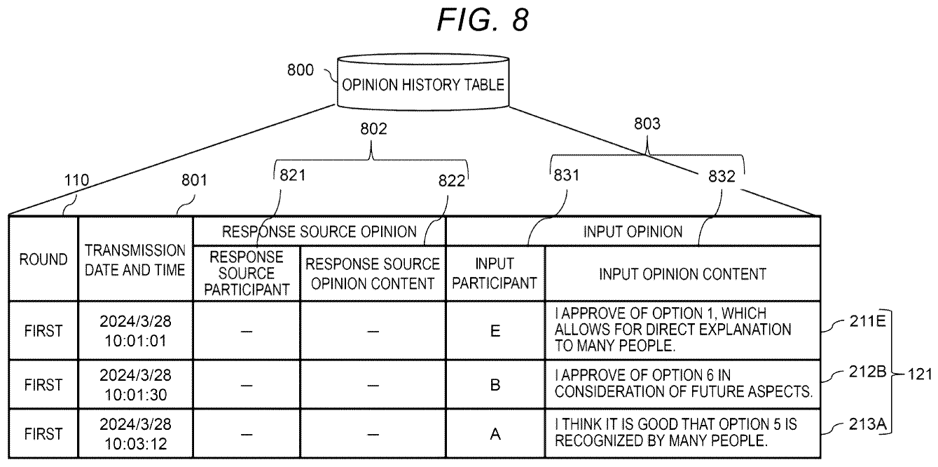

### FIG. 8 Example 1 of Opinion History Table (First Round 110)

FIG. 8 is a diagram showing an example 1 of an opinion history table. An opinion history table 800 is a table for recording the opinion 2nmX acquired in step S601, and is stored in the storage device 402.

The opinion history table 800 includes, as fields, the round 110, a transmission date and time 801, a response source opinion 802, and an input opinion 803. The transmission date and time 801 is a date and time when the communication terminal 303 transmits the input opinion 803. Instead of the transmission date and time 801, the date and time when the participant X of the communication terminal 303 inputs the input opinion 803 to the communication terminal 303 may be used, or the date and time when the consensus building support device 301 receives the input opinion 803 may be used.

The response source opinion 802 is an opinion serving as a response source of the input opinion 803, and is specified by the designation information acquired in step S601. The response source opinion 802 includes a response source participant 821 and a response source opinion content 822. The response source participant 821 is the participant X who has transmitted the response source opinion content 822. The response source opinion content 822 is the opinion 2nmX transmitted by the response source participant 821.

The input opinion 803 is opinion information transmitted from the communication terminal 303 at the transmission date and time 801, and specifically includes, for example, an input participant 831 and an input opinion content 832. The input participant 831 is the participant X who has transmitted the input opinion content 832. The input opinion content 832 is the opinion 2nmX transmitted by the input participant 831. That is, an entry in the first row is the opinion 211E, an entry in the second row is the opinion 212B, and an entry in the third row is the opinion 213A.

### Step S602

Returning to FIG. 6, the consensus building support device 301 extracts, from the opinion history table 800, the opinion 2nmX (input opinion 803) acquired in step S601 in the current n-th round 110.

### Step S603

The consensus building support device 301 specifies an option selected by the participant X in the input opinion 803 extracted in step S602. Specifically, for example, the consensus building support device 301 specifies, as the option selected by the input participant 831, an option included in the input opinion content 832 of the input opinion 803 extracted in step S602.

Depending on a context of the input opinion content 832, it may be difficult to specify whether the option included in the input opinion content 832 is an option approved by the input participant 831 or an option disapproved by the input participant 831. Therefore, the consensus building support device 301 may specify the option that the input participant 831 has approved (or the option has disapproved) using a learning model that has been machine-learned in advance. Hereinafter, for convenience of description, an option approved by the input participant 831 will be described, and an option disapproved by the input participant 831 can be similarly executed.

Specifically, for example, the consensus building support device 301 inputs the input opinion content 832 of the input opinion 803 extracted in step S602 to a learning model that estimates an option approved by the participant X, and outputs an estimated option approved by the input participant 831.

The learning model is, for example, a classifier that is machine-learned using a training data set that is a combination of training data indicating opinion contents prepared in advance and ground truth data that is an approval option. The learning model may be implemented in a computer capable of communicating with the consensus building support device 301.

In the first round 110, an estimated option of the participant E in the opinion 211E is “option 1”, an estimated option of the participant B in the opinion 212B is “option 6”, and an estimated option of the participant A in the opinion 213A is “5”.

### Step S604

The consensus building support device 301 combines a plurality of opinions 2nmX having the same approval option. Specifically, for example, the consensus building support device 301 groups a plurality of opinions 2nmX having the same estimated option, and combines the opinions 2nmX in each group in ascending order of the transmission date and time 801 within the group.

When a certain participant X selects an option different from that of another participant Y by using an opinion 2nmY of another participant Y (X) as a response source, the consensus building support device 301 combines the opinion 2nmX of the participant X with the opinion 2nmY as an opinion of a lower hierarchy of the opinion 2nmY of the response source.

Even in a case where a certain participant X selects an option different from that of another participant Y using the opinion 2nmY of another participant Y as a response source, when the participant X finally has an opinion 2nmX for selecting the same option as the option of another participant Y, the consensus building support device 301 combines a series of opinions 2nmX of the participant X and the opinion 2nmY of another participant Y as the same group.

As described above, the combined opinion 2nmX is referred to as a combination result. The combination result exists for each group. In the first round 110, since the opinions 2nmX having the same estimated option do not exist, the opinion 211E, the opinion 212B, and the opinion 213A are not combined with each other. In other words, each of the opinion 211E, the opinion 212B, and the opinion 213A indicates a combination result including only one opinion 2nmX.

### Step S605

The consensus building support device 301 transmits the combination result in step S604 to the communication terminal 303. In the first round 110, the consensus building support device 301 transmits, as a combination result, the opinion 211E, the opinion 212B, and the opinion 213A to each communication terminal 303.

In the first round 110, since the opinion 211E, the opinion 212B, and the opinion 213A are not combined, in the communication terminal 303, the opinion 211E, the opinion 212B, and the opinion 213A are displayed in independent figures as a combination result.

The processing of steps S601 to S605 described above is executed each time the opinion 2nmX is acquired.

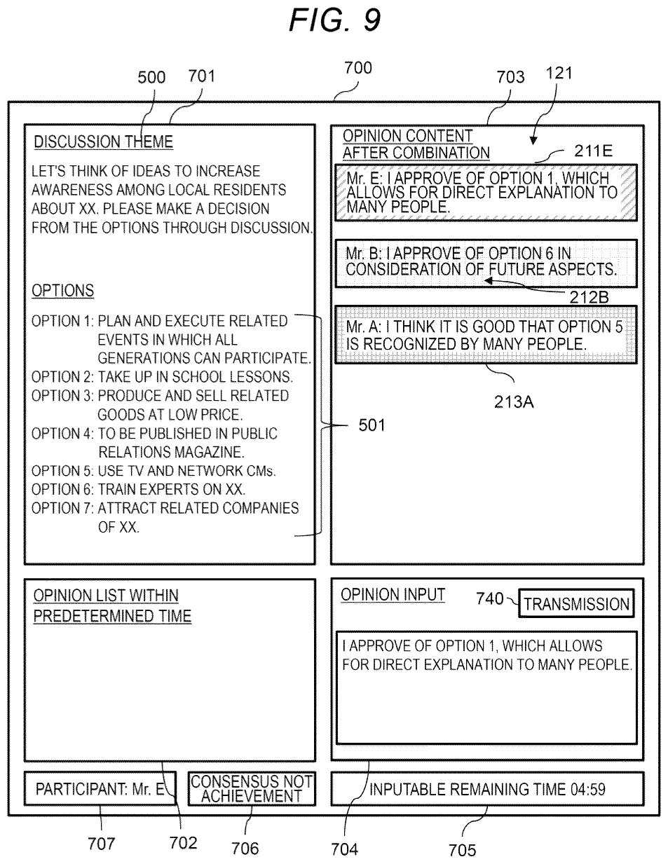

### FIG. 9 Example 2 of Display Screen (First Round 110)

FIG. 9 is a diagram showing an example 2 of the display screen of the communication terminal 303. FIG. 9 shows the display screen 700 of the communication terminal 303 of the participant E, and shows a state where the opinions 211E, 212B, and 213A as the combination result are displayed in the combined opinion display region 703 in the first round 110. Specifically, for example, when the participant E inputs “I approve of option 1, which allows for direct explanation to many people.” as the opinion 211E in the opinion input region 704 and presses the transmission button 740, the communication terminal 303 transmits the opinion 211E.

The consensus building support device 301 transmits the opinion 211E to all the communication terminals 303 by the processing of steps S601 to S605. The communication terminal 303 displays the opinion 211E in the combined opinion display region 703. The opinions 212B and 213A are similarly displayed in the combined opinion display region 703.

### Step S606

Returning to FIG. 6, the consensus building support device 301 determines whether a discussion state is consensus achievement in the n-th round 110. Specifically, for example, the consensus building support device 301 determines whether a notification of the consensus achievement has been received from the communication terminal 303 of the facilitator 100 within a certain time after the end of the time limit of the n-th round 110. When the notification of the consensus achievement is received (step S606: Yes), the processing proceeds to step S607. When the notification of the consensus achievement is not received (step S606: No), the processing proceeds to step S608.

### Step S607

The consensus building support device 301 notifies the communication terminal 303 of the consensus achievement. Accordingly, the consensus state display region 706 on the display screen 700 of the communication terminal 303 is changed from “consensus not achievement” to “consensus achievement”. Accordingly, consensus building support processing ends.

### Step S608

In the n-th round 110, the consensus building support device 301 determines whether the discussion state is that convergence is impossible. Specifically, for example, the consensus building support device 301 determines whether a notification that convergence is impossible has been received from the communication terminal 303 of the facilitator 100 within a certain time after the end of the time limit of the n-th round 110. When the notification that convergence is impossible is received (step S608: Yes), the processing proceeds to step S609. When the notification that convergence is impossible is not received (step S608: No), the processing proceeds to step S610.

The consensus building support device 301 may determine that the discussion state is that convergence is impossible when the number of rounds n reaches an upper limit number of N (N is a preset integer of 1 or more) even if the notification that convergence is impossible is not received.

### Step S609

The consensus building support device 301 notifies the communication terminal 303 that convergence is impossible. Accordingly, the consensus state display region 706 on the display screen 700 of the communication terminal 303 is changed from “consensus not achievement” to “convergence is impossible”. Accordingly, the consensus building support processing ends.

### Step S610

The consensus building support device 301 increments the number of rounds n. Accordingly, steps S601 to S605 are newly executed in the n-th round 110.

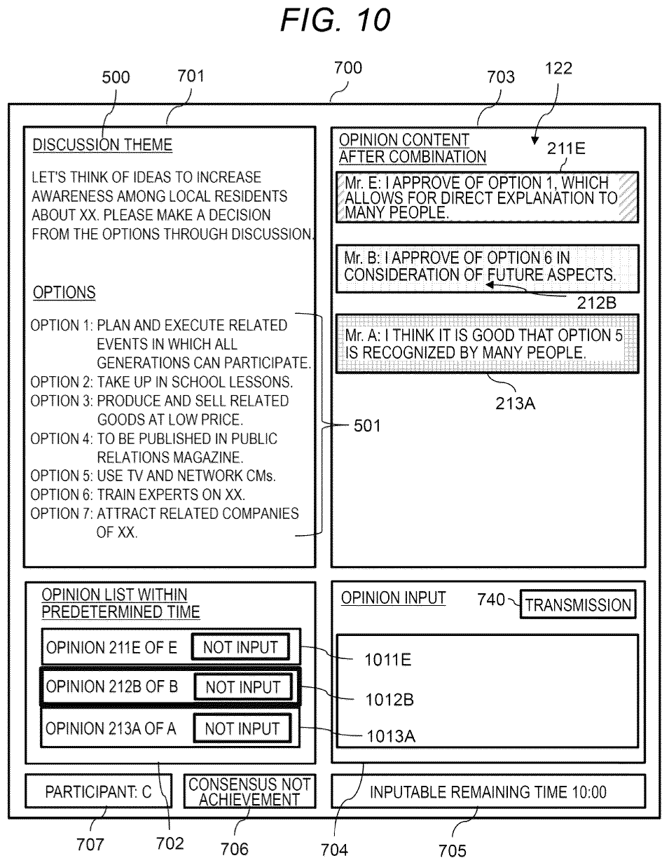

### FIG. 10 Example 3 of Display Screen (Second Round 110)

FIG. 10 is a diagram showing an example 3 of the display screen of the communication terminal 303. FIG. 10 is the display screen 700 of the communication terminal 303 of the participant C, and shows a display content at the start time (step S610) of the second round 110. In the opinion list display region 702, response source designation information 1011E, 1012B, and 1013A of the opinions 211E, 212B, and 213A are displayed so as to be designated.

When receiving the designation of the response source designation information 1011E, 1012B, and 1013A by the operation of the participant C, the communication terminal 303 highlights the received response source designation information 1011E, 1012B, and 1013A. In FIG. 10, the response source designation information 1012B is designated, and the frame is highlighted with a thick line.

The communication terminal 303 highlights the corresponding opinions 211E, 212B, and 213A of the combined opinion display region 703 in conjunction with the designation of the response source designation information 1011E, 1012B, and 1013A. In FIG. 10, since the response source designation information 1012B is designated, the opinion 212B is cooperatively displayed in bold. Accordingly, the participant C can intuitively grasp the opinion 212B transmitted by the participant B within a predetermined period.

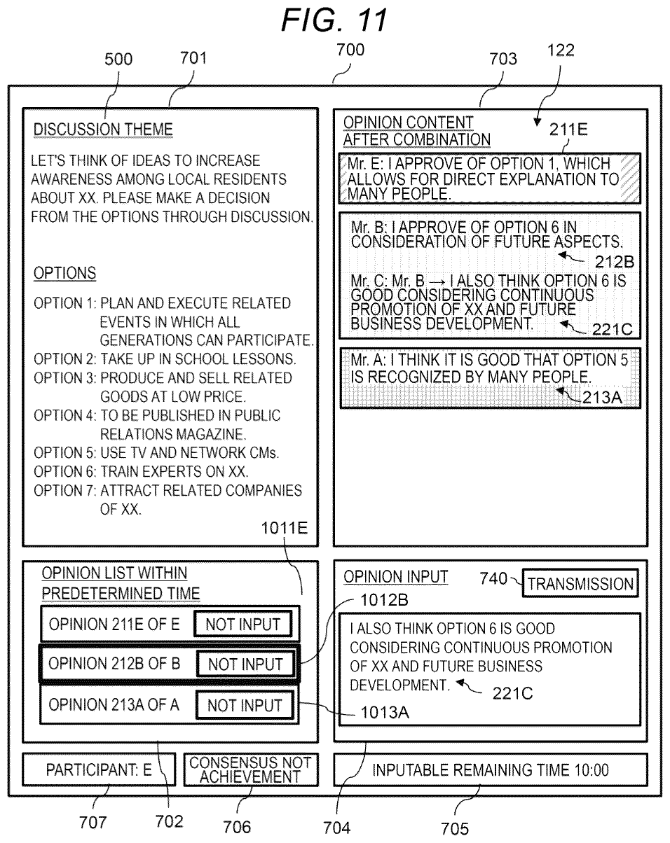

### FIG. 11 Example 4 of Display Screen (Second Round 110)

FIG. 11 is a diagram showing an example 4 of the display screen of the communication terminal 303. FIG. 11 is a display screen 700 of the communication terminal 303 of the participant C, and shows a display content when the opinion 221C is input in the second round 110. When the opinion 221C is input to the opinion input region 704 and the transmission button 740 is pressed in a state where the response source designation information 1012B of the opinion list display region 702 is designated, the communication terminal 303 designates the opinion 212B as the response source opinion and transmits the opinion 221C to the consensus building support device 301.

By executing steps S601 to S605, the consensus building support device 301 combines the opinion 212B and opinion 221C because the options are the same, and transmits the combination result {212B, 221C} to all the communication terminals 303. Accordingly, the communication terminals 303 display the combination result {212B, 221C} in which the opinion 212B and the opinion 221C are surrounded by one figure in the combined opinion display region 703. Further, “not input” in the response source designation information 1012B is updated to “input completed”.

When the communication terminal 303 of the participant E designates the opinion 213A of the participant A as the response source opinion and transmits the opinion 222E, the consensus building support device 301 combines the opinion 213A of the participant A and the opinion 222E of the participant E by executing steps S601 to S605. Since the opinion 213A and the opinion 222E have different options, the opinion 222E is combined with the lower hierarchy of the opinion 213A, and separate figures are combined and displayed as a combination result [213A, 222E].

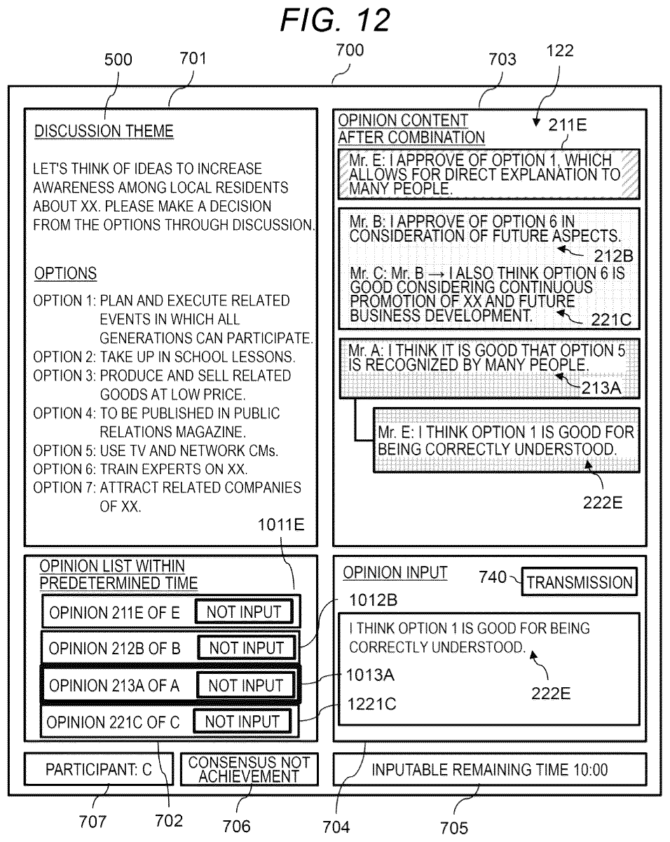

### FIG. 12 Example 5 of Display Screen (Second Round 110)

FIG. 12 is a diagram showing an example 5 of the display screen of the communication terminal 303. FIG. 12 is a display screen 700 of the communication terminal 303 of the participant E, and shows a display content when the opinion 222E is input in the second round 110. When the opinion 222E is input to the opinion input region 704 and the transmission button 740 is pressed in a state where the response source designation information 1013A of the opinion list display region 702 is designated, the communication terminal 303 designates the opinion 213A as the response source opinion and transmits the opinion 222E to the consensus building support device 301.

By executing steps S601 to S605, the consensus building support device 301 combines the opinion 222E with the opinion 213A as the opinion of the lower hierarchy of the opinion 213A due to the option difference, and transmits the combination result {213A, 222E} to all the communication terminals 303. Accordingly, the communication terminal 303 displays the combination result {213A, 222E} in which the opinion 212B and the opinion 221C are connected by different figures in the combined opinion display region 703. Further, “not input” in the response source designation information 1013A is updated to “input completed”.

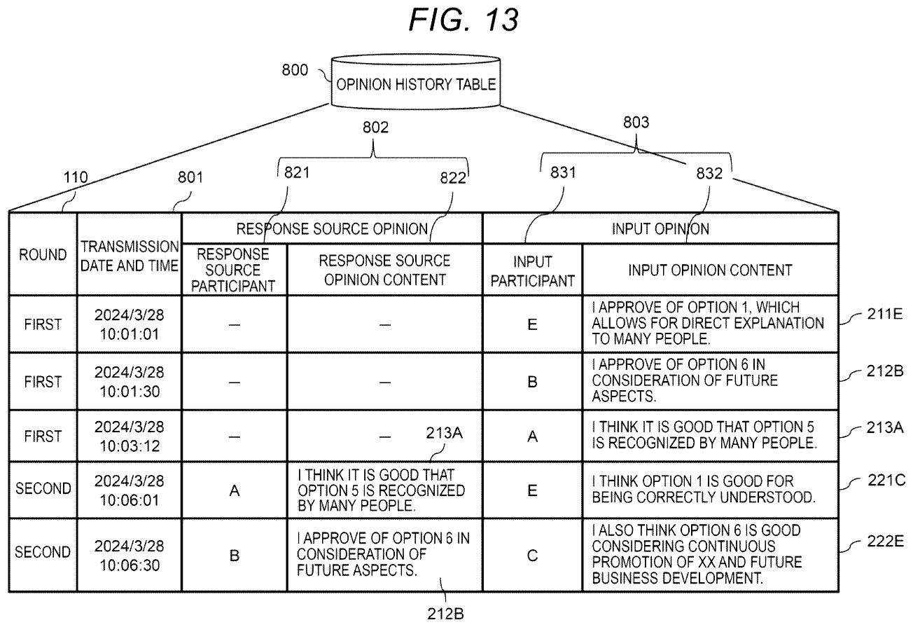

### FIG. 13 Example 2 of Opinion History Table (Second Round 110)

FIG. 13 is a diagram showing an example 2 of the opinion history table. FIG. 13 shows an update state of the opinion history table 800 in the second round 1109 (n=2). Specifically, for example, as shown in FIGS. 11 and 12, entries of the opinions 221C and 222E are added to the opinion history table 800. The opinion 221C is an opinion in which the opinion 213A is designated as the response source opinion 802, and the opinion 222E is an opinion in which the opinion 212B is designated as the response source opinion 802.

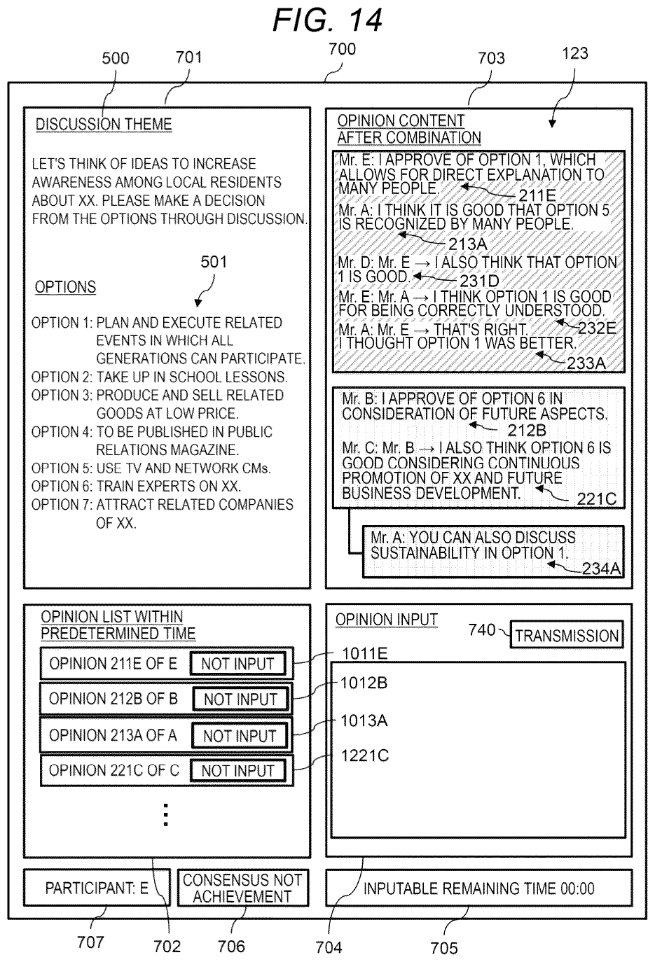

### FIG. 14 Example 6 of Display Screen (Third Round 110)

FIG. 14 is a diagram showing an example 6 of the display screen of the communication terminal 303. FIG. 14 is the display screen 700 of the communication terminal 303 of the participant E, and shows a display content at the end of the third round 110.

Specifically, for example, in FIG. 14, the opinions 211E, 213A, 231D, 232E, and 233A are combined by the option 1 in the combined opinion display region 703 to configure the combination result {211E, 213A, 231D, 232E, 233A}.

Although the participant A selects the option 5 in the opinion 213A in the first round 110, since the option 5 is changed to the option 1 in the opinion 233A in the third round 110, the opinion 213A of selecting the option 5 is also included in the combination result {211E, 213A, 231D, 232E, 233A}. Accordingly, by referring to the combination result {211E, 213A, 231D, 232E, 233A}, it is possible to grasp how the participant A has changed the option 5 to the option 1.

In the combined opinion display region 703, the opinions 212B and 221C are combined by the option 6 to configure the combination result {212B, 221C}.

In the combined opinion display region 703, the opinion 234A is an opinion for selecting the option 1 different from the option 6 of the opinions 212B and 221C, but since the opinion 212B (or the opinion 221C) is the response source opinion, the opinion 234A is combined with the lower hierarchy of the combination result {212B, 221C}, and a combination result [{212B, 221C}, 234A] is obtained.

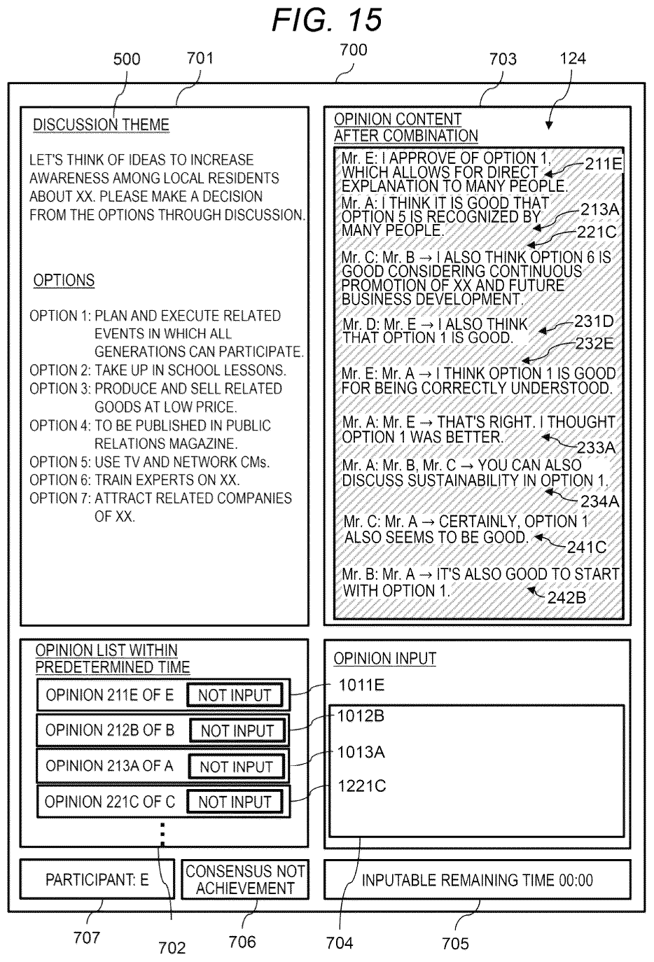

### FIG. 15 Example 7 of Display Screen (Fourth Round 110)

FIG. 15 is a diagram showing the example 6 of the display screen of the communication terminal 303. FIG. 15 is the display screen 700 of the communication terminal 303 of the participant E, and shows a display content at the end of the fourth round 110.

Specifically, for example, in FIG. 15, in the combined opinion display region 703, the opinions 211E, 213A, 221C, 231D, 232E, 233A, 234A, 241C, and 242B are combined by the option 1 to configure a combination result {211E, 213A, 221C, 231D, 232E, 233A, 234A, 241C, 242B}.

Although the participant A selects the option 5 in the opinion 213A in the first round 110, since the option 5 is changed to the option 1 in the opinion 233A in the third round 110, the opinion 213A of selecting the option 5 is also included in the combination result {211E, 213A, 221C, 231D, 232E, 233A, 234A, 241C, 242B}.

Although the participant C selects the option 6 in the opinion 221C in the second round 110, since the option 6 is changed to the option 1 in the opinion 241C in the fourth round 110, the opinion 221C of selecting the option 6 is also included in the combination result {211E, 213A, 221C, 231D, 232E, 233A, 234A, 241C, 242B}.

Accordingly, by referring to the combination result {211E, 213A, 221C, 231D, 232E, 233A, 234A, 241C, 242B}, it is possible to grasp how the participant A has changed the option 5 to the option 1 and how the participant C has changed the option 6 to the option 1.

One combination result {211E, 213A, 221C, 231D, 232E, 233A, 234A, 241C, 242B} is displayed in the combined opinion display region 703. Therefore, the facilitator 100 can easily determine consensus achievement.

Upon receiving the notification of the consensus achievement from the communication terminal 303 of the facilitator 100, the consensus building support device 301 transmits, to all the communication terminals 303, an instruction to change the consensus state display region 706 from “consensus not achievement” to “consensus achievement”. Accordingly, the consensus state display region 706 is changed from “consensus not achievement” to “consensus achievement”.

As described above, according to the embodiment, it is possible to prompt convergence of the discussion by combining the opinions of the participant X, and to easily determine whether the discussion has ended, that is, whether the consensus is achieved, based on the degree of combination. Accordingly, it is possible to support consensus building in which convergence is particularly difficult with a large number of participants.

In the embodiment described above, the facilitator 100 determines whether the consensus is achieved by viewing the display screen 700, but when the combination result converges to one, the consensus building support device 301 may determine that the consensus is achieved, and may transmit, to all the communication terminals 303, an instruction to change the consensus state display region 706 from “consensus not achievement” to “consensus achievement”.

In the embodiment described above, the consensus is achieved when the combination result converges to one, but when the combination result converges to a predetermined number of 2 or more, the discussion state may be regarded as the consensus achievement in step S606.

The invention is not limited to the embodiment described above and includes various modifications and equivalent configurations within the scope of the appended claims. For example, the embodiment described above is described in detail for easy understanding of the invention, and the invention is not necessarily limited to those including all the configurations described above. A part of a configuration of one embodiment may be replaced with a configuration of another embodiment. A configuration of one embodiment may also be added to a configuration of another embodiment. Another configuration may be added to a part of a configuration of each embodiment, and a part of a configuration of each embodiment may be deleted or replaced with another configuration.

A part or all of the above configurations, functions, processing units, processing methods, and the like may be implemented by hardware by, for example, designing with an integrated circuit, or may be implemented by software by, for example, a processor interpreting and executing a program for implementing each function.

Information in a program, a table, a file, or the like for implementing each function can be stored in a storage device such as a memory, a hard disk, or a solid state drive (SSD), or in a recording medium such as an integrated circuit (IC) card, an SD card, or a digital versatile disc (DVD).

Control lines and information lines considered to be necessary for descriptions are shown, and not all control lines and information lines necessary for implementation are shown. Actually, it may be considered that almost all the configurations are connected to one another.

1. A consensus building support device comprising:
a processor configured to execute a program;
a storage device configured to store the program; and
a communication interface configured to communicate with a plurality of communication terminals used by a plurality of participants, wherein
the processor executes
acquisition processing of receiving, from the communication terminals, an opinion related to a discussion for determining any one option from among a plurality of options, as a result of transmitting information related to the discussion to the plurality of communication terminals,
specifying processing of specifying an option selected by the participant for each opinion received by the acquisition processing,
combining processing of combining the opinions based on the option specified by the specifying processing, and
transmission processing of transmitting, to the communication terminals, a combination result obtained by combining the opinions by the combining processing.

2. The consensus building support device according to claim 1, wherein
in the specifying processing, an output result from a learning model, which estimates the option when the opinion is input, is specified as the option selected by the participant by inputting the opinion to the learning model.

3. The consensus building support device according to claim 1, wherein
in the combining processing, the processor combines opinions having the same options, and
in the transmission processing, the processor transmits, to the communication terminals, a first combination result obtained by combining the opinions having the same options in the combining processing.

4. The consensus building support device according to claim 3, wherein
in the transmission processing, the processor transmits the first combination result so that the opinions are displayable as information in a same figure.

5. The consensus building support device according to claim 1, wherein
in the combining processing, the processor combines a first opinion of a first participant selecting a first option and a second opinion of a second participant selecting a second option in response to the first opinion, and
in the transmission processing, the processor transmits, to the communication terminals, a second combination result obtained by combining the first opinion and the second opinion by the combining processing.

6. The consensus building support device according to claim 5, wherein
in the transmission processing, the processor transmits the second combination result in a displayable manner as information in which a first figure having the first opinion and a second figure having the second opinion are connected.

7. The consensus building support device according to claim 5, wherein
in the combining processing, the processor further combines a third opinion of the first participant selecting the second option, and
in the transmission processing, the processor transmits, to the communication terminals, a third combination result obtained by combining the first opinion, the second opinion, and the third opinion in the combining processing.

8. The consensus building support device according to claim 7, wherein
in the transmission processing, the processor transmits the third combination result so that the first opinion, the second opinion, and the third opinion are displayable as information in a same figure.

9. The consensus building support device according to claim 1, wherein
the processor repeatedly executes the acquisition processing, the specifying processing, the combining processing, and the transmission processing within a time limit.

10. The consensus building support device according to claim 9, wherein
the processor repeatedly executes a round in which the acquisition processing, the specifying processing, the combining processing, and the transmission processing are repeatedly executed within the time limit.

11. The consensus building support device according to claim 10, wherein
the processor repeatedly executes the round until the combination result converges to one.

12. A consensus building support method executed by a consensus
building support device including a processor configured to execute a program, a storage device configured to store the program, and a communication interface configured to communicate with a plurality of communication terminals used by a plurality of participants, wherein
the processor executes
acquisition processing of receiving, from the communication terminals, an opinion related to a discussion for determining any one option from among a plurality of options, as a result of transmitting information related to the discussion to the plurality of communication terminals,
specifying processing of specifying an option selected by the participant for each opinion received by the acquisition processing,
combining processing of combining the opinions based on the option specified by the specifying processing, and
transmission processing of transmitting, to the communication terminals, a combination result obtained by combining the opinions by the combining processing.

13. A computer-readable recording medium storing instructions to execute:
acquisition processing of receiving, from a plurality of communication terminals, an opinion related to a discussion for determining any one option from among a plurality of options, as a result of transmitting information related to the discussion to the plurality of communication terminals;
specifying processing of specifying an option selected by the participant for each opinion received by the acquisition processing;
combining processing of combining the opinions based on the option specified by the specifying processing; and
transmission processing of transmitting, to the communication terminals, a combination result obtained by combining the opinions by the combining processing.
